(19) United States
(12) Patent Application Publication
(10) Pub. No.: US 2005/0073469 A1
(43) Pub. Date: Apr. 7, 2005

(54) Multimedia advertising billboard

(76) Inventors: Hsi-Che Lee, Taipei (TW); Tung-Hsing Pan, Taipei (TW); Mei-Jiuan Chen, Taipei (TW)

Correspondence Address: BIRCH STEWART KOLASCH & BIRCH, PO BOX 747, FALLS CHURCH, VA, 22040-0747, US

(21) Appl. No.: 10/678,188

(22) Filed: Oct. 6, 2003

(51) Int. Cl. G09G 5/00

(52) U.S. Cl. 345/1.1

(57) ABSTRACT

A multimedia advertising billboard includes a waterproof box with two liquid crystal displays on right and left sides respectively. The waterproof box is arranged on the outer wall of buildings while the two liquid crystal displays are connected to a computer inside the building. By the multimedia program of computer, animated advertisements are shown on the liquid crystal displays for promoting products. The advertisement can be changed depending on the needs of the users.

### BACKGROUND OF THE INVENTION

1. Field of the Invention

The present invention relates to a multimedia advertising billboard, especially to a billboard having a waterproof box with liquid crystal displays, or plasma display panels on right and left sides for showing animated advertisement. The advertising picture can be replaced according to the need of the users.

2. Description of the Prior Art

Generally the advertising billboard arranged on the outer wall of stores is composed of a transparent acrylic plate, a plurality of light tubes disposed inside a frame, trade name of firm with other color is attached on the acrylic plate or is formed directly on the surface of the acrylic plate by relief printing and then the words of trade name are painted with a color different from that of the acrylic plate. The advertising billboard is lighted at night. Such billboard is a bit monotonous so that there is another way to light the light tubes behind the trade name, word after word. However, there is still a space for improvement.

There is a further way to dispose neon lights or colorful bulbs outside the advertising billboard, or the trade name is composed of neon lights and some other simple figures. The neon lights are lighted in preset order so as to animate the advertisement. The variability of the billboard is still quite limited. The cost for making an advertisement billboard is quite high, thus unless it is too old to use, it's impossible to change a new one.

Furthermore, there is a kind of advertising billboard with large screen made by light emitted diode. Although it's dynamic, but the colors and the figures are limited. And such kind of advertisement is shown in a single plane and just can be seen clearly in the front side. In addition, the cost for producing such LED advertisement is quite high, only big company can afford it.

Advertisements generally installed on top of the taxi or on the outside of the buses are static planes that can not attract much attention of people.

### SUMMARY OF THE INVENTION

It is therefore a primary object for the present invention to provide an advertising billboard that is composed of a waterproof box with two liquid crystal displays disposed on the right and left sides respectively for showing animated advertisement. The advertisement can be changed according to the need of users.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional view of the present invention;

FIG. 3 is another embodiment of the present invention;

FIG. 4 is a further embodiment of the present invention.

### DETAILED DESCRIPTION OF THE PREFERRED EMBODIMENT

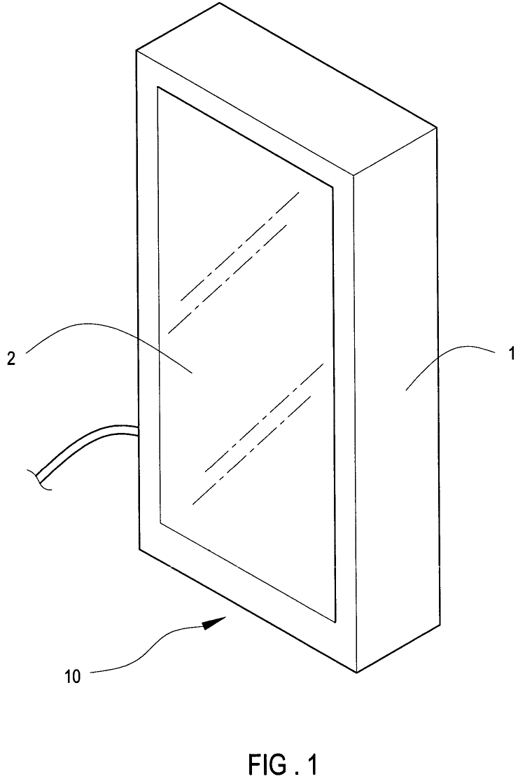

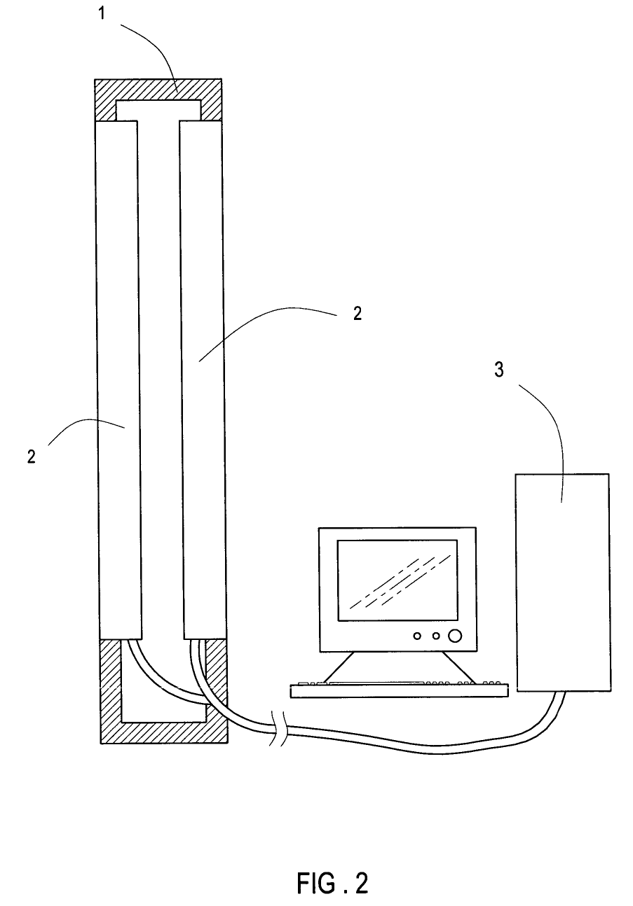

Refer to FIG. 1 & FIG. 2, the present invention includes a waterproof box 1 and two liquid crystal displays 2, thus forms an advertising billboard 10. Each of the components are described in the following:

The waterproof box is a rectangular box that is installed on the outer wall of the buildings. The two liquid crystal displays 2 are disposed on the right and left sides of the waterproof box 1 and are connected with a computer 3 or Micro Processing Unit (MPU) inside a building for running the multimedia program. Thus the animation is displayed on the liquid crystal displays 2 so as to show the animated advertisement.

In accordance with the structure mentioned above, the liquid crystal displays 2 installed on right and left sides of the advertising billboard 10 are controlled by the computer 3 or Micro Processing Unit (MPU) that runs the multimedia program so as to display the animated pictures or the trade name of firms. By setting the multimedia program, the advertising pictures can be displayed in turn. This is convenient for firms to operate. On the other hand, manufactures only need to provide the users the same multimedia program for different application without designing specific programs for each one.

Moreover, the liquid crystal displays 2 are arranged on two sides of the advertising billboard 10 so as to achiever better advertising effect for passersby.

Furthermore, the resolution and quality of the liquid crystal displays 2 is far better than the light-emitting diode.

In addition, the liquid crystal displays 2 can be replaced with a PDP (plasma display panel). This is another embodiment of the present invention.

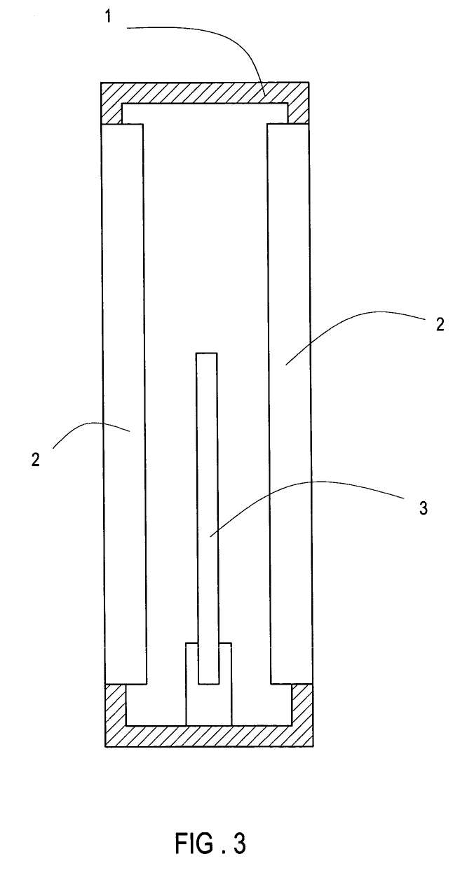

Refer to FIG. 3, the computer 3 or Micro Processing Unit (MPU) can be disposed inside the waterproof box 1 so as to integrated with the waterproof box 1 into one unit. A keyboard and a mouse (not shown in figure) can be connected to the computer 3 and both are enclosed inside the waterproof box 1 while being used. This is a further embodiment of the present invention.

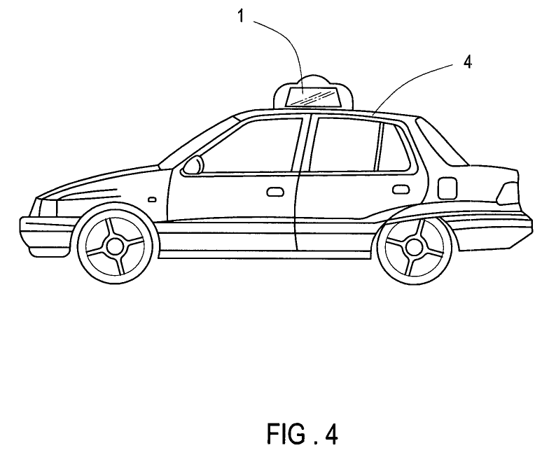

Refer to FIG. 4, the waterproof box 1 with the computer 3 or Micro Processing Unit (MPU) inside can be installed on the car 4 roof so that the animated advertisement is displayed on the car 4. This is a further embodiment of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A multimedia advertising billboard comprising
a waterproof box that is a rectangular box that is installed on the outer wall of buildings;
two liquid crystal displays arranged on the left and right sides of the waterproof box and connected with a computer inside the buildings so as to play animated advertisement by the program of the computer.

2. The multimedia advertising billboard as claimed in claim 1, wherein the liquid crystal display can be replaced by a plasma display panel.

3. The multimedia advertising billboard as claimed in claim 1, wherein the computer is disposed inside the waterproof box.

4. The multimedia advertising billboard as claimed in claim 1, wherein the computer is disposed inside the waterproof box that is installed on a car.
